(19) United States
(12) Patent Application Publication
(10) Pub. No.: US 2026/0203715 A1
(43) Pub. Date: Jul. 16, 2026

(54) METHOD AND SYSTEM FOR GENERATING DYNAMIC BUILDING INSPECTION CHECKLISTS

(71) Applicant: TedFordAI Inc., Ripley (CA)

(72) Inventor: Matt FARRELL, Ripley (CA)

(21) Appl. No.: 19/444,311

(22) Filed: Jan. 9, 2026

Related U.S. Application Data
(60) Provisional application No. 63/743,666, filed on Jan. 10, 2025.

(51) Int. Cl. G06Q 10/10; G06Q 50/08

(52) U.S. Cl. CPC G06Q 10/103; G06Q 50/08

(57) ABSTRACT

The disclosure is directed at a method and system for generating dynamic building inspection checklists. The system and method compares tasks for a construction project with building code requirements and then generates a building inspection checklist based on the comparison. The system and method may then determine which tasks within the inspection checklist may result in a more negative impact if the task does not pass inspection and updates the checklist accordingly.

### CROSS-REFERENCE TO OTHER APPLICATIONS

The disclosure claims priority from U.S. Provisional Application No. 63/743,666 filed Jan. 10, 2025 which is hereby incorporated by reference.

### FIELD

The disclosure is generally directed at building inspections, and more specifically, at a method and system for generating dynamic building inspection checklists.

### BACKGROUND

As cities continue to grow, there is also an increase in the number of construction projects that take place throughout the city. These construction projects may include new industrial buildings, new commercial buildings, new housing projects or even improvements or upgrades on current city buildings.

As a construction project is being performed, regular building inspections are required to monitor progress of the construction project tasks. The building inspections are typically required to ensure safe practices are being used and that all of the tasks meet building code requirements. However, current building inspections do not rank or grade construction features based on the negative impact that not meeting a building code requirement may cause. Current building inspections are also quite cumbersome.

Therefore, there is provided a novel method and system for generating dynamic building inspection checklists.

### SUMMARY

In one aspect of the disclosure, there is provided a method of facilitating building inspections for a construction project including receiving construction project information, the construction project information including tasks that are to be performed for the construction project; determining building code requirements associated with tasks received in the construction project information; generating a building inspection checklist of building inspection tasks based on determined building code requirements.

In another aspect, the method further includes, after receiving the construction project information storing the construction project information. In a further aspect, the method further includes receiving updated construction project information; and storing the updated construction project information. In yet another aspect, the method includes transmitting the building inspection checklist to a user. In yet a further aspect, the method includes receiving results with respect to the building inspection checklist. In yet another aspect, the method includes tracking deficiencies for each item in the building inspection checklist. In an aspect, the method includes linking building inspection tasks with construction project information.

In another aspect, the method includes predicting a cause of deficiency. In a further aspect, predicting a cause of deficiency includes correlating the deficiency with a set of predetermined variables. In yet another aspect, the method includes determining a frequency of deficiency for the deficiency being tracked. In yet a further aspect, the method includes calculating a consequence score for each deficiency being tracked. In yet another aspect, the method includes performing a risk evaluation based on the consequence scores. In yet a further aspect, the method includes generating an updated building inspection checklist ranking building inspection tasks from highest risk score to lowest risk score.

### BRIEF DESCRIPTION OF THE DRAWINGS

Further features and advantages of the present disclosure will become apparent from the following detailed description, taken in combination with the appended drawings, in which:

FIG. 1 is a schematic diagram of a system for generating dynamic building inspection checklists in an operational environment;

FIG. 2 is a schematic diagram of a system for generating dynamic building inspection checklists;

FIG. 3a is a flowchart showing one method of generating dynamic building inspection checklists;

FIG. 3b is a flowchart showing another embodiment of a method of generating dynamic building inspection checklists;

FIG. 4a is a flowchart showing a method of calculating or generating consequence scores;

FIG. 4b is a chart showing different costs;

FIG. 4c is a schematic diagram of a building code requirement;

FIG. 5 is a frequency distribution; and

FIG. 6 is a risk chart.

### DETAILED DESCRIPTION OF THE EMBODIMENTS

The disclosure is directed at a method and system for generating dynamic building inspection checklists. In one embodiment, the disclosure receives building inspection inputs from a user, such as, but not limited to, a building inspector, and then processes the building inspection inputs to generate a building inspection checklist that is directly relevant to the project be examined. In some embodiments, the project specific building inspection checklist may provide an indication as to which building inspection tasks may be more important, may have a larger impact on society if failed or may have a higher or lower failure rate.

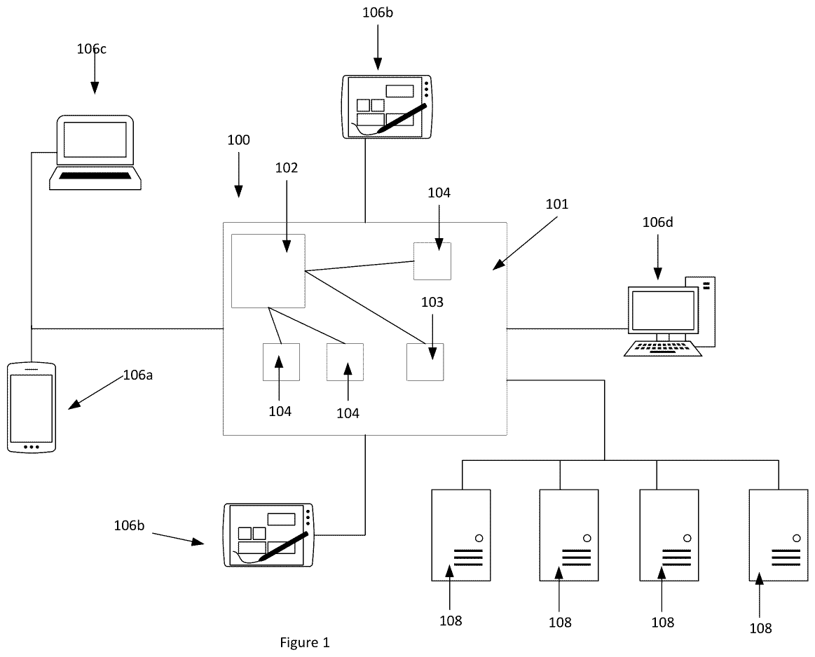

Turning to FIG. 1, a schematic diagram of a system for generating dynamic building inspection checklists in an operational environment is shown. The system 100 includes a processor 102 for communicating with and/or for executing a set of modules 104 that provide functionality for generating dynamic building inspection checklists. In some embodiments, the system 100 is stored within a server 101 or in the Cloud. The system 100 may also include a database 103 that stores information or data required to facilitate building inspections or generate dynamic building inspection checklists. The digital information or digital data may be required by the system 100 to function or may be digital information or digital records that are generated or created by the system 100. The database 103 may also store other digital information such as, but not limited to, building design information, property data, building data and inspector qualifications.

System 100 communicates with a set of communication, or user communication, devices 106 that are associated with individuals that use these devices 106 and require or desire access to the system 100. Examples of communication devices 106 include, but are not limited to, Smartphone 106a, tablet 106b, laptop 106c, desktop 106d and the like. For embodiments where the system 100 is integrated within or with a larger building construction or building inspection platform, the communication devices 106 may be mobile or portable communication devices, and the users of the platform access the system 100 through an application or app executing or stored on their mobile communication devices 106. In these embodiments, the communication device 106 may have stored within their memory, software, such as in the form of the application or app, that enables the communication device 106 to access the system 100 directly or via the building inspection platform. In other embodiments, the communication devices 106 may be used to log into or onto an online network or application that is stored within or associated with the system 100 or to login to the building inspection platform to access the system 100. Individuals accessing the system 100 may include, but are not limited to, building inspectors, building inspection managers, plans examiners and building department administrators. Builders and tradespeople may also have separate and unique access to the system 100 in order to obtain pre-inspection checklists specific to the project that they are working on. In some embodiments, the system provides the builder of tradesperson with a same list of tasks to ensure that areas with the highest probability of failing are constructed properly.

The system 100 may be further connected to, and in communication with, other servers 108 that store or host external digital data such as, but not limited to building codes, completed inspection records, building design, property data, builder data or inspector qualifications. These servers 108 may be associated with or managed by third parties that provide content for access through the system 100 to the individuals accessing the building inspection platform or for the system itself.

Communication between system 100 and the communication devices 106 and/or servers 108 may be over a network using TCP/IP; Ethernet; ATM SONET/SDNET; over air; copper wires; optical fiber or any other transmission systems capable of carrying data.

In one embodiment, the network is the Internet and the communication devices 106 may be connected to the network, or Internet, in a variety of ways, such as, but not limited to, via a wired network, via a cellular network, via Wi-Fi, or via Bluetooth™. A skilled person will understand that server 101 may include multiple servers in a cluster or other similar shared-processing or distributed-processing architectures, whether in a single location or over cloud computing.

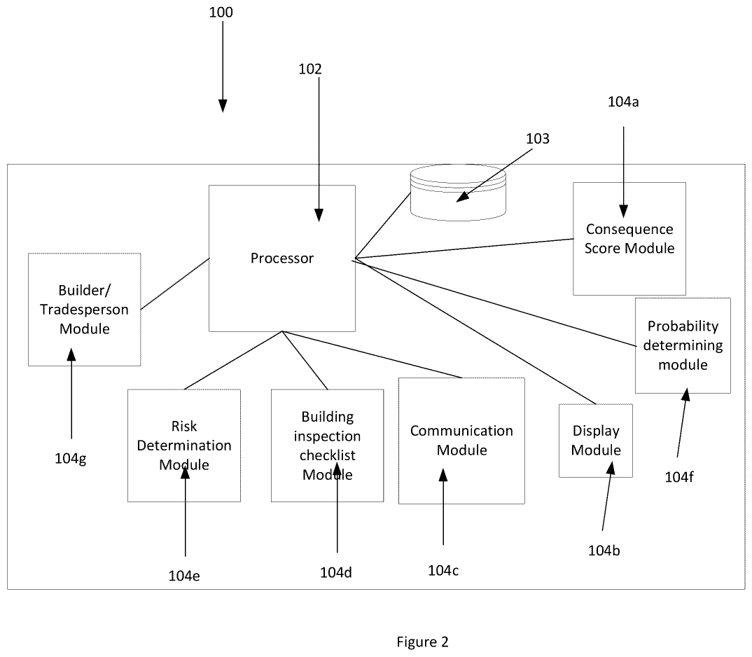

Turning to FIG. 2, a schematic diagram of the system for generating dynamic building inspection checklists is shown. As can be seen in FIG. 2, the system 100 includes the processor 102 which is connected to, or in communication with, the set of modules 104. The system 100 may further include database 103 that stores data or information that may be accessed by processor 102. In some embodiments, along with the examples taught above, the database 103 may also store previously completed inspection records, current inspection records and/or building code inspection checklists. In other embodiments, the database 103 may also store links to the other servers 108 in order for the system to communicate with these servers to retrieve and or transmit digital information, such as in the form of digital data, to perform a method of facilitating or improving building inspections. The database 103 may also be used to store other digital information or digital data for an online building construction network or platform that may not be used by the system 100.

In the current embodiment, the set of modules 104 includes a consequence score module 104a, a display module 104b, a communication module 104c, a building inspection checklist module 104d, a risk determination module 104e, a probability determining module 104f and a builder/tradesperson module 104g. Although connections are only shown between the processor 102 and the modules 104 and the processor 102 and the database 103, it is understood that modules 104 may be connected to, or in communication with, each other and with the database 103 even though these connections are not shown in FIG. 2.

In one embodiment, the consequence score module 104a provides the functionality to generate or calculate consequence scores associated with different tasks in a building inspection checklist. Each task in the checklist represents a set of features that an inspector needs to examine in order to determine if the construction project is in compliance with the applicable building codes. The features being examined include, but are not limited to, the materials being used, the construction details (the way the materials are utilized, placed or connected to one another) and the parameters those materials and details must meet.

As described in more detail below, the consequence score for a task may represent the impact that failure of the task during a building inspection may have with respect to criteria such as, but not limited to, human cost; environmental issues; social issues and/or economical issues. In some embodiments, the consequence module 104a may obtain values associated with an impact on each of the criteria to determine the consequence score for a task. The communication module 104c enables communication between the system 100 and the communication devices 106 and/or the servers 108. The display module 104b may generate images and/or screens that are displayed on the different communications devices for transmitting or displaying information to the users. The screens may include inspection checklists (in-progress or completed) or may show other digital information.

In some embodiments, the building inspection checklist module 104d provides the functionality to generate inspection checklists for a construction project. The checklist module 104d may receive a set of tasks that are being performed in a construction project and then retrieve building code requirements for each of these tasks. The building code requirements may be retrieved from servers 108 or may be retrieved from the database 103.

The risk determination module 104e provides the functionality of determining a level of risk for each task of a building inspection checklist. The risk may be seen as a combination of the probability that a building inspection task may not be approved or may not pass inspection and the consequence score assigned to the task.

The probability module 104f performs the functionality to determine the likelihood a task on the building inspection checklist may fail to pass inspection. In one embodiment, the probability module 104f retrieves previous inspection results with respect to the task. The probability module 104f may then process these results to determine how often the task has passed inspection and how often it has failed inspection. It is understood that for a single construction project, the task may fail inspection at least one time before it passes inspection and therefore, the inspection results may also include information with respect to how many times the task was failed before it was approved. This may be based on inspections performed by local inspectors or inspections performed nationally or internationally. In some embodiments, this may also be based on global building inspection results.

The builder/tradesperson module 104g provides the functionality to provide a module for a builder or tradesperson to access the building inspection checklist to prepare for the official building inspection. It provides the builder/tradesperson with the checklist so that the builder/tradesperson can review those builder features or building tasks to ensure they have been constructed properly.

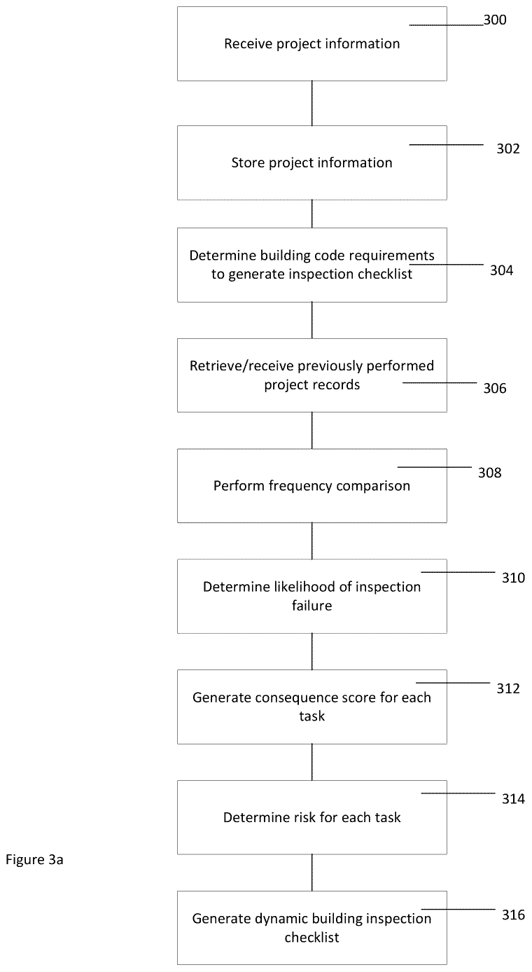

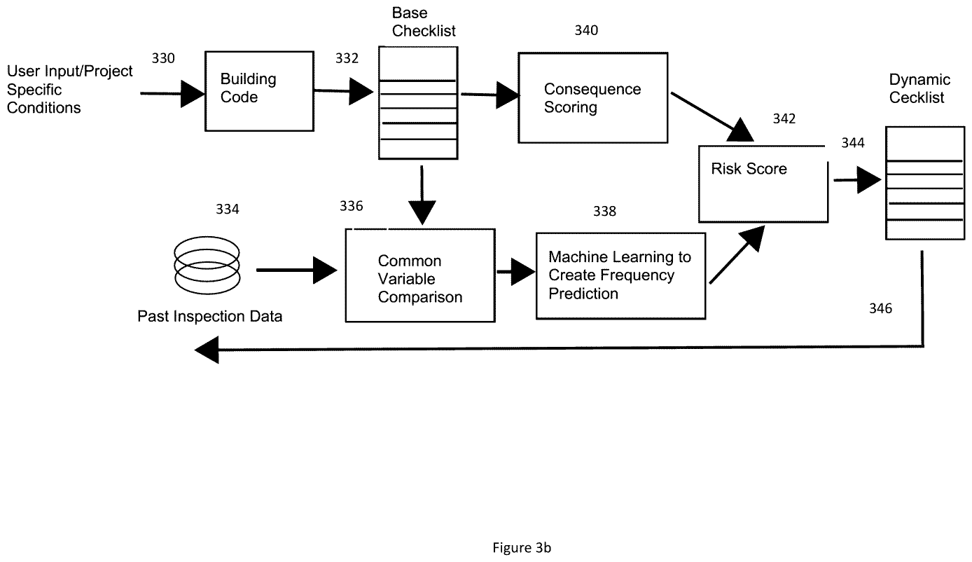

Turning to FIG. 3a, a flowchart showing a method of generating dynamic building inspection checklists is shown. Initially, the system receives project or construction project information (300). The information may be either input into the system by a user (such as via their communication device) or may be retrieved from one of the servers or the database by the system or a combination of both types of inputs. The project information may include, but is not limited to, a permit number; property information (i.e. civic address, legal address, roll #, and the like); building type (i.e. residential; Industrial, Commercial & Investment (ICI); Farm); building part number (Part 3 or Part 9 for Canadian National Building Code (CNBC); or Part 7, 8 10/11 for the Ontario Building Code (OBC)); occupant load; building area; project tasks; location (geographic information system (GIS) or Building Code Location) and/or Applicant information (name, role, contact information phone/email). As the construction project proceeds, other construction project information such as, but not limited to, site conditions; climatic data (rain/wing/snow loads); seismic potential; radon potential; the type of construction; soil type (i.e. sand or clay engineered fill); type of insulation installed (i.e. fiberglass or spray foam) and/or presence of natural hazards (proximity to slops, water courses, unstable soils) may be input into the system, to update the initial construction project information, by a user, such as a building inspector. It is understood that while a lot of different types of project information have been listed, not all of the construction project information may be required or input each time or, in some embodiments, other project information may be received by the system. Once the information has been received, the system may store the project information in the database (302) such as in the form of a project record. The system may continue to update the database in real-time with additional construction project information or if any updates to previously stored construction project information are made.

The system then determines building code requirements (304) based on the construction project information that has been received. The building code requirements are associated with tasks that have been entered as part of the construction project or project information. The identified building code requirements may then be added to the record or may be used to create or generate a checklist of building code requirements or a building inspection checklist which may then be added to the record or stored as a separate document or item. The checklist of building code requirements may then be displayed or transmitted to the user so that the user can refer to it during a building inspection.

After the checklist has been generated, the checklist can be provided to the user, or building inspector, for performance of a building inspection. As outlined above, the checklist lists all the features or tasks that need to be reviewed based on the building code requirements comparison and/or a set of inspection notes associated with the tasks.

In performing the inspection, the building inspector will analyze the construction project to see if the construction project is in compliance with the building code requirements or if there are deficiencies. In other words, the building inspection uses the checklist to determine if the work associated with a required checklist task passes or fails the building code requirements. If deficiencies are found, the building inspector marks the failure by recording the failure in the checklist. The checklist may be a physical checklist where the building inspector checks a PASS/FAIL box and then the results are entered into a database at a later time or the checklist may be a digital checklist where the building inspector enters results for the inspection into their communication device that either stores and/or transmits this information to the system for processing. In some embodiments, a report based on the building inspection results may be generated.

For each building checklist item or task, if a deficiency is identified it will reference the building code provision or requirement that it has been associated with. In some embodiments, a task may be associated with more than one building code provision. The variables that are entered will determine the building code provision required to be in compliance with for each individual project. The system will track the number of deficiencies recorded for each provision of the building code.

In one specific example, during the inspection to determine if a deficiency is present, the building inspector may look at a specific material, detail or feature of the construction project that is associated with a task listed in the building inspection checklist. The system links each building code provision or requirement to the specific material, detail or feature (whether in one or multiple building inspection checklist tasks) that may be present during the building inspection. For example, with respect to “Footings” for a construction project, (which may be associated with Section 9 which covers the construction of small housing in the Canadian building code), the building inspection checklist may associate or connect all tasks in the building inspection checklist related to materials, details or features used in the construction of footings with Section 9 as the building code requirement. As such, each of these building inspection tasks may be designated as Footing by the system for the current building inspection checklist and/or future building inspection checklists. The system may then link at least some of the construction project inputs (received in 300) to a specific group of provisions. For example, the soil type input may be linked to all those provisions or building inspection tasks related with “Footings” or Section 9 of the building code. When a deficiency is recorded in a report, the project input is also recorded as part of the report file.

The system then retrieves data (such as from the server or the database), from previous inspections (306). The previous inspection data may be from previously completed inspections that are saved in the database or from servers representing inspection data from previously completed inspections from other jurisdictions or municipalities. In some embodiments, the data that is retrieved is in the form of a pass/fail annotation for each provision or task in the previous building inspection checklist associated with the deficiency being tracked. For data that is retrieved based on inspections performed in other jurisdictions (which may be subject to different building codes), the system may perform an equivalency process, determination or calculation to align the different building code requirements or provisions in the building inspection checklist with these other inspections. Data may also be collected for results of inspection for the stage (pass/fail/outstanding issues). In other words, at the completion of an inspection, the inspector will pass the inspection and let construction continue, fail the inspection and stop progress until issues are resolved or identify outstanding issues that need to be fixed by the next inspection (not severe enough to stop construction but still needs to be addressed).

Based on the collected or received information, the system may then predict a cause of deficiency. This may also be seen as a common variable comparison/frequency based on specific variables (308). As will be understood, deficiencies may be caused by different variables present within the construction project. In one embodiment, the system analyzes the data or record that has been stored to determine if there are trends based on specific variables or a frequency of how often specific variables are used. Examples of variables include, but is not limited to, environmental information specific to a location (i.e. soil type, flood potential, seismic zone, wind/snow loads); recency of code requirement or how new a requirement is; frequency of deficiencies or how often a deficiency is found locally, provincially or nationally; and/or deficiencies related to builder/tradespeople or how an individual is making repeated mistakes in a specific area. Each deficiency will be cross referenced against these variables to identify if correlation exists.

For example, if a high number of deficiencies are observed in locations with high wind load requirements, the system can predict that those deficiencies are likely to occur in other locations with similar wind load requirements. Also, if a high number of deficiencies are identified on a construction project which is a new requirement in the building code or there has been a recent change in the building code requirement, the system can predict that other tasks (in other building inspection checklists) associated with the new or altered building code requirements may see a high number of deficiencies.

In other embodiments, the system may determine a frequency that the deficiency has occurred in other building inspections or determine a likelihood of deficiency for each building code requirement or task on the building inspection checklist (310). In other words, the system determines how likely tasks might not pass inspection. In one embodiment, the system determines a likelihood or frequency that a deficiency will occur for each building code requirement identified in the building inspection checklist. In some embodiments, the determination is performed using machine learning.

For some building code requirements or provisions, there may not be enough data from previous building inspections to determine an accurate frequency score (as discussed in more detail below). When construction project inputs are entered that do not have enough data to determine an accurate frequency score, the system uses machine learning algorithms to predict the frequency for the building code provisions that regulate construction on a project.

The majority of the algorithms used will fall under the supervised learning category as it will use inputs and outputs from previous projects to make predictions. Most predictions may be made using linear or logistic regression models, however, classification of outcomes using K-nearest neighbour clustering may also be used.

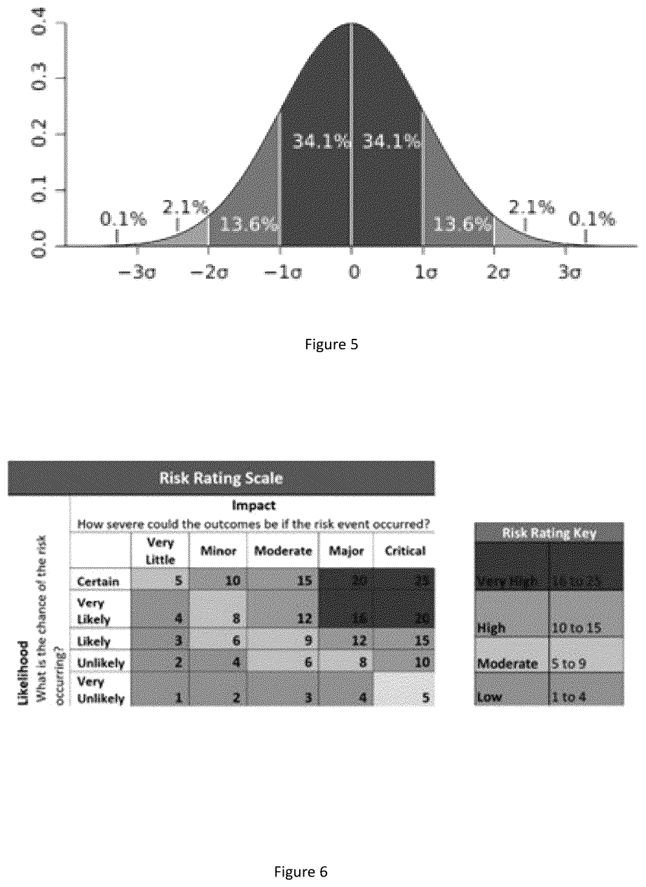

The system then determines a frequency score. For each building code provision, the number of deficiencies identified in previous construction projects (or previous building inspection results) are totaled and a frequency score calculated. For example, if there are 8000 building inspection results stored and 40 of those construction projects identify a “footing” deficiency (a provision within Section 9), the system calculates a frequency score based on the occurrence of the deficiency in every 200 projects or, a 0.5% chance of that deficiency occurring. In embodiments where there is insufficient data, a predicted frequency can be used based on projected outputs from machine learning models. In some embodiments, the frequency score can be determined based on a normal distribution of the frequencies of deficiencies for all code provisions. It is anticipated that deficiencies with the highest probability of occurring will likely happen in one out of every 10 construction projects and the data spread for each compliance issue will have unique variability. For this reason, in some embodiments, the system can use a standard deviation model to determine the probability score. As schematically shown in FIG. 5, frequencies between −3 standard deviations and −1 standard deviation are very unlikely; frequencies between −1 standard deviation and 0 are unlikely; frequencies between 0 and 1 standard deviation are likely; frequencies between 1 standard deviation and 2 standard deviations are very likely and frequencies above 2 standard deviations are certain. These values are used as the frequency score.

In order to address anomalies, the system may use unsupervised learning principles to help identify outlier instances or sudden surges in deficiencies being reported for given building code provisions. This may occur when an inspector fails a task where past data shows that compliance is highly likely. This can occur from the inspector having a misunderstanding of the building code requirement or the inspector having biases toward a builder or building practice. In these situations, the system highlights the anomaly to the user and direct them to reinspect the construction project task or building inspection task.

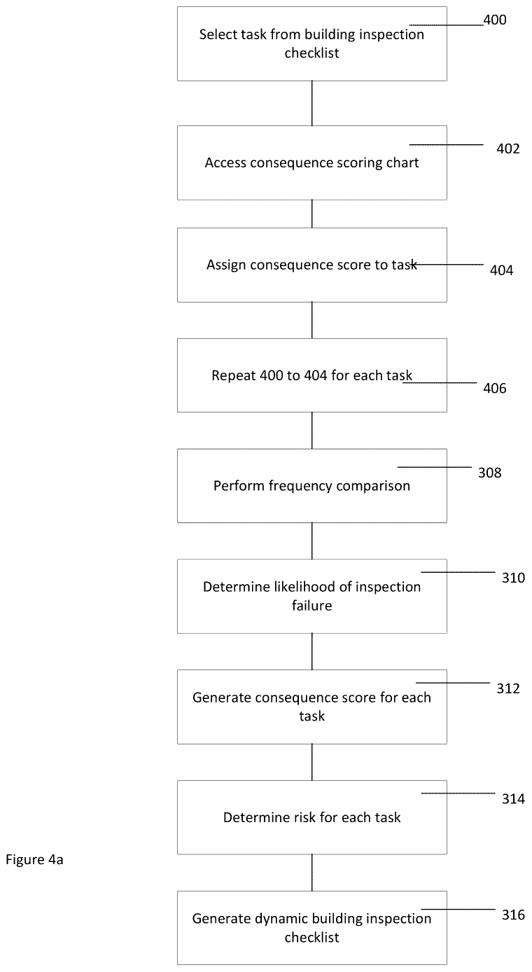

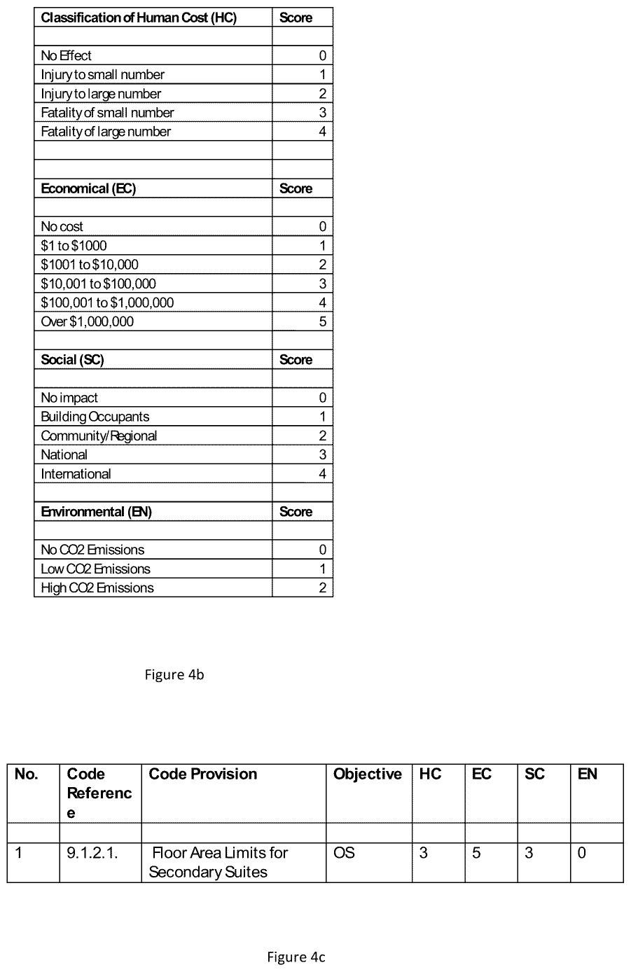

The system then generates a consequence score or performs consequence scoring (312) to generate a consequence score for each task. In some embodiments, a consequence score is calculated for each deficiency being tracked and not for every task in the building inspection checklist. The consequence scoring may be seen as generating or calculating a score that represents the effects of how bad a failure of one of the tasks may be. In some embodiments, a consequence score is given to each requirement or task of the building inspection checklist based on the worst outcome if failure were to occur due to deficient construction. Further details are provided with respect to FIG. 4.

For example, the Canadian National Building Code is in an objective-based format which provides the consequence for each building code requirement and its aim is to prevent or reduce the likelihood of its impact on society. For example, with respect to injury, loss of life, financial loss, waste of resources and other factors. The consequence scores remain static unless an event occurs that shows failure for a given task leads to greater/less consequence. In most embodiments, each requirement or task of the building inspection checklist is assigned a consequence score.

After generating the consequence scores, the system performs a risk evaluation (314). The risk evaluation is based on the consequence scores and the likelihood score where both are used to calculate a risk score for each task within the building inspection checklist. In one embodiment, the likelihood is determined from past data i.e. how many times a deficiency has been discovered vs the total number of projects the item has been inspected on. A table showing one example of how the risk evaluation may be performed is shown in FIG. 6.

In the figure, likelihood is provided on the Y-axis while the consequence value is provided on the X-axis. As can be seen from the chart, if the likelihood of a task failing inspection is certain and the consequence is moderate, the risk may be seen as high. Alternatively, if the likelihood of a task failing inspection is likely but the consequences are critical, the risk may also be seen as high. If the likelihood of a task failing inspection is unlikely and there are minor consequences, the risk is low.

After the risk evaluation has been completed, the system then creates or generates a dynamic or updated building inspection checklist (316). In one embodiment, the dynamic checklist is created by sorting the tasks in the original building inspection checklist from a highest risk score to a lowest risk score so that a person reviewing the updated building inspection checklist understands which items should be given priority attention during an inspection.

After an inspection has been completed, the system then stores the completed record in the database. The record can then be used in future executions of the current method of the disclosure such as with respect to (306). In some embodiments, the new data (or the completed record) may be fed into a machine learning model to help refine the machine learning model to provide more accurate predictions. If there are outstanding tasks that have not passed inspection, the record may be seen as incomplete or partially complete whereby it may be updated if tasks are passed during a subsequent inspection. Each time an inspection is completed, a new inspection record or checklist is created. The new checklist or inspection record may be saved as a next version so that it can be associated or connected to the original building inspection checklist.

FIG. 3b provides a schematic diagram of another embodiment of a method of facilitating or improving building inspections. Initially, as with the method of FIG. 3a, construction project specific conditions or information are received by the system (330). In some embodiments, the construction project conditions may be input by a user into the system while in other embodiments, the construction project conditions are retrieved from a database or an external server storing different construction project conditions. In yet other embodiments, the project conditions may be received via a combination of user input and retrieval from external or internal servers and/or databases. Examples of construction project conditions or construction project information are discussed above with respect to FIG. 3a.

The system then processes at least some of the construction project conditions to determine or generate a building code checklist or building inspection checklist (332) which may represent the different inspections that need to be performed and passed for the construction or building project to be approved or stages of the construction or building project to be passed.

As the project conditions are being received (330) and the building code checklist is being generated (332), past inspection data or information may be concurrently received or retrieved by the system (334). As will be understood, this past inspection data may be continuously received by the system as inspections continue to be performed and tasks approved or failed. In some embodiments, the past inspection data may provide a timeline with respect to the progress of other prior building inspections. The past building inspection data may be used to provide analytics with respect to how often certain tasks on the current building inspection checklist are approved and/or how many attempts or inspections may be required for a task in the current building inspection checklist to be approved. The past inspection data may also be used to determine if there are outstanding issues for previous projects which need to be followed up on i.e. not approved during prior inspection(s). As discussed above, the past inspection data may relate to information that is associated with previously performed inspections in the current jurisdiction. In some embodiments, the system may be used to facilitate building inspections for different jurisdictions with different building codes so the past data that is stored may not be relevant for all new projection conditions or all generated building checklists.

After the building inspection checklist is generated (332), the system performs a variable comparison and/or frequency determination (336). In one embodiment, the system performs analytics or analysis on the different tasks in the building inspection checklist. For example, the system may use address information and date information to determine likely weather conditions or likely working conditions for the construction project which may result in the building inspector needing to look at other factors or variables during the inspection. The system may also determine how often a task in the building inspection checklist is failed either locally or in a different jurisdiction. This may signal the building inspector to pay closer attention to the construction work associated with certain tasks during the inspection or approval process.

Results of the variable comparison and/or frequency determination are then further processed to determine or create a frequency prediction (338) or likelihood score. In one embodiment, this process is performed via machine learning that has been taught or filled with the past inspection data and previous common variable and/or frequency determinations. Based on the results of past inspections, prior analysis or analytics, and other data, the system may then determine how frequent or likely a deficiency will be found with respect to each task in the building inspection checklist.

As the frequency prediction is generated or determined, consequence scoring may be performed for each task in the building code or inspection checklist (340). A consequence score may be seen as a value that represents a worst-case scenario score or indicator where a value higher or lower (depending on how the system is set up) than a predetermined value may represent the severity of an outcome if failure of that task were to occur during the construction process. For example, the consequence score with respect to a foundation for a construction project that is not poured correctly would likely be greater (higher risk to human health and safety or higher dollar cost to fix) compared with the consequence score with respect to an error with respect to plumbing. Other examples may include, but are not limited to, handrails that cannot withstand an applied force which may result in severe injury or death from a fall or a handrail that extends too far that may cause an obstruction for pedestrian travel whereby an individual may get injured by bumping into it.

The set of consequence scores generated in (340) and the set of frequency predictions generated in (338) are then combined or analyzed to generate a set of risk scores (342). In other words, a risk score combines the likelihood of a construction task failure (or likelihood of a task on the checklist not being approved) with the potential worst-case scenario outcome to determine which tasks on the checklist are of most concern and which should be inspected more carefully. The basic equation is risk =probability x consequence.

The original building inspection checklist can then be updated to reflect the risk scores associated with the tasks (344) and, if desired, the building inspection checklist may be updated in risk score order. In this manner, tasks that have a higher risk score may be given priority attention during inspection.

After an inspector uses the updated (or dynamic) building inspection checklist for an inspection, results of the inspection (in accordance with the dynamic checklist) may be stored (346) within the database. Depending on the results, the checklist may be updated as more inspections are performed and more tasks approved. In another embodiment, the checklist may be stored by version number such that progress of inspections may also be analyzed and/or stored for analytics or for use at other times.

Turning to FIG. 4a, a flowchart showing an embodiment of a method for calculating or generating consequence scores is shown. Generally, when performing their roles, building inspectors can make hundreds of determinations as to whether compliance with the building code has been obtained at the given stage of construction. In other words, during an inspection, there are many variables which come into play to determine if a task should be approved or fail inspection. While not explicitly expressed in building codes, non-compliance with certain provisions can lead to more severe consequences and therefore carry a greater level of risk.

Building codes in Canada are in an objective-based format in which every technical or building code requirement fulfills one or more of the stated objectives. This is a similar structure to the model building codes used in other North American and international countries. The objectives for national building codes are safety (OS), health (OH), accessibility (OA), fire and structural protection of buildings (OP) and environment (OE). These objectives identify the consequence each provision of the building code is attempting to limit the probability of. For each category, there is a greater degree of liability associated with failure i.e. if the task does not pass inspection but is not corrected.

For each building code requirement, there are a number of consequences that may occur if construction is not in compliance. With respect to the disclosure, a worst-case scenario is established as the potential consequence with respect to non-compliance (or failure to pass inspection) for each requirement. Consequences are generally classified in the following categories: Human—injuries, fatalities; Economical—repair of damage; Environmental—CO₂ emissions, resource waste and/or Social—loss of reputation, loss of trust

In one embodiment, the disclosure may provide for each provision of the building code, a consequence score for each category based on the associated objectives and the worst-case scenario if a failure occurs. In other embodiments, the disclosure may calculate a consequence score for each task in the building inspection checklist.

Initially, the system selects one of the tasks from the building code or inspection checklist (400). The system may then refer (402) to a consequence scoring chart (such as the example table of FIG. 4b). In some embodiments, each task of the building inspection checklist may be associated with one of the digitally stored building code requirements such that when the system is generating the consequence score, it is connected to the correct building code equivalent. The scoring chart of FIG. 4b provides an example of the types of consequences that are relevant to building construction and/or inspection and assigns a value or score to each of the levels of consequence with a higher value representing a higher consequence or cost. For example, with respect to “Classification of Human Cost (HC)”, if failure to pass inspection for this task has no effect on human cost, the consequence value is “0”; if failure to pass inspection for this task may result in injury to a small number of humans, the consequence value is “1”; if failure to pass inspection for this task may result in injury to a large number of humans, the consequence value is “2”; if failure to pass inspection for this task may result in a small number of fatalities, the consequence value is “3” and if failure to pass inspection for this task may result in a large number of fatalities, the consequence value is “4”. The consequence score for other objectives, namely economical, social and environmental are also shown in FIG. 4b.

In some embodiments, the table is shown to a building inspector who enters a selection and the score associated with that selection is then stored in the system and assigned to the task in the building inspection checklist (404). In another embodiment, the system may perform its own consequence value determination.

For example, as schematically shown in FIG. 4c, a building code checklist task relates to “Floor area limits for Secondary Suites”. In this example, the system has assigned an overall consequence score of 11 for this task. Breaking this down, a consequence value associated with a “Classification of Human Cost” was “3” which indicates that failure to pass inspection may result in a small number of fatalities; a consequence value associated with “Economics” was “5” which indicates that failure of pass inspection may result in a cost of “over $1,000,0000” to fix, remedy or compensate; a consequence value associated with a “Social” was “3” which indicates that failure to pass inspection may result in an impact nationally; and a consequence value associated with a “Environmental” was “0” which indicates that failure to pass inspection does not result in any CO₂ emissions. The calculated consequence scores are then processed along with other factors to generate a risk score as discussed above with respect to FIGS. 3a and 3b.

The system repeats this for each of the consequences associated with a building inspection checklist task (406) to generate a consequence score for each task in the building code checklist.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

What is claimed:

1. A method of generating a dynamic building inspection checklist for a construction project comprising:
receiving construction project information, the construction project information including tasks that are to be performed for the construction project;
determining building code requirements associated with tasks received in the construction project information; and
generating a building inspection checklist of building inspection tasks based on determined building code requirements.

2. The method of claim 1 further comprising, after receiving the construction project information:
storing the construction project information.

3. The method of claim 2 further comprising:
receiving updated construction project information; and
storing the updated construction project information.

4. The method of claim 1 further comprising:
transmitting the building inspection checklist to a user.

5. The method of claim 1 further comprising:
receiving results with respect to the building inspection checklist.

6. The method of claim 5 further comprising:
tracking deficiencies for each item in the building inspection checklist.

7. The method of claim 6 further comprising:
linking building inspection tasks with construction project information.

8. The method of claim 7 further comprising:
predicting a cause of deficiency.

9. The method of claim 8 wherein predicting a cause of deficiency comprises:
correlating the deficiency with a set of predetermined variables.

10. The method of claim 6 further comprising:
determining a frequency of deficiency for the deficiency being tracked.

11. The method of claim 10 further comprising:
calculating a consequence score for each deficiency being tracked.

12. The method of claim 11 further comprising:
performing a risk evaluation based on the consequence scores.

13. The method of claim 12 further comprising:
generating an updated building inspection checklist ranking building inspection tasks from highest risk score to lowest risk score.
